(19) United States
(12) Patent Application Publication
(10) Pub. No.: US 2026/0237774 A1
(43) Pub. Date: Aug. 13, 2026

(54) DEVICE AND METHOD FOR REVERSE SEPARATION AND DISASSEMBLY OF JELLY ROLLS

(71) Applicant: RIKOMAY RECYCLING SINGAPORE PTE. LTD., Singapore (SG)

(72) Inventors: Xiaowei LI, Wuhan (CN); Yuancheng CAO, Wuhan (CN); Xiaosong ZHANG, Wuhan (CN); Bao CHEN, Wuhan (CN); Xiuye WANG, Wuhan (CN)

(21) Appl. No.: 19/639,152

(22) Filed: Apr. 4, 2026

(30) Foreign Application Priority Data
Jul. 2, 2025 (CN) 202510910442.8

(51) Int. Cl. H01M 10/54

(52) U.S. Cl. CPC H01M 10/54

(57) ABSTRACT

A device for reverse separation and disassembly of jelly rolls, including: a lifting mechanism, a limiting mechanism, a primary cutting mechanism and an unwinding mechanism. The lifting mechanism is configured to lift a jelly roll. The primary cutting mechanism is configured to cut a surface separator layer. The unwinding mechanism is configured to grip and transfer the jelly roll to a separator stripping mechanism. The unwinding mechanism is provided with a blowing brush connected to an air source via a pipeline. A negative electrode collecting mechanism is arranged on a frame between the limiting mechanism and the separator stripping mechanism. A separator separation mechanism, a secondary cutting mechanism and a positive electrode collecting mechanism are sequentially arranged between the separator stripping mechanism and a film-drawing mechanism.

### CROSS-REFERENCE TO RELATED APPLICATIONS

This application claims the benefit of priority from Chinese Patent Application No. 202510910442.8, filed on July 2, 2025. The content of the aforementioned application, including any intervening amendments made thereto, is incorporated herein by reference in its entirety.

### TECHNICAL FIELD

This application relates to recycling of waste lithium-ion batteries, and more particularly to a device and method for reverse separation and disassembly of jelly rolls.

### BACKGROUND

The vigorous development of the new energy automotive industry has greatly promoted the production and application of lithium-ion power batteries in recent years. The service life of lithium-ion power batteries is generally 5 to 8 years, so more and more power batteries will enter the enticement phase.

Due to the presence of various valuable metals such as nickel, cobalt, manganese and lithium, lithium-ion power batteries exhibit high potential for recycling and regeneration. To this regard, waste power batteries are referred to as “urban mining”. Existing methods for disassembling lithium-ion power batteries mostly rely on manual operations, which results in large labor and space consumption and poor automation level. Moreover, the existing methods also pose safety risks and significant environmental pollution, and are no longer suitable for large-scale recycling and disassembly.

### SUMMARY

An object of the disclosure is to provide a device and method for reverse precise separation and disassembly of jelly rolls, so as to address the problems of manual operation, low efficiency and high safety risks caused by the existing disassembly of laminated jelly rolls.

Technical solutions of the present disclosure are described as follows.

In a first aspect, this application provides a device for reverse separation and disassembly of jellyrolls, comprising:

a frame;

a limiting mechanism;

a separator striping mechanism; and

a film-drawing mechanism;

wherein the limiting mechanism, the separator stripping mechanism and the film-drawing mechanism are sequentially provided on the frame;

the frame is provided with a primary cutting mechanism, and the primary cutting mechanism is configured to cut a surface separator layer of a jelly roll limited by the limiting mechanism;

the frame is provided with a lifting mechanism and an unwinding mechanism; and the lifting mechanism is configured to lift the jelly roll limited by the limiting mechanism in a Z-axis direction;

the unwinding mechanism is configured to grip and transfer the jelly roll limited by the limiting mechanism to the separator striping mechanism, and unwind the jelly roll;

the unwinding mechanism is provided with a blowing brush connected to an air source through a pipeline;

an airflow from the blowing brush is directed toward a cut position at the surface separator layer of the jelly roll gripped by the unwinding mechanism, so as to cause an end of the surface separator layer at the cut position to be separated and gripped by the separator stripping mechanism;

the frame is further provided with a negative electrode collecting mechanism, and the negative electrode collecting mechanism is provided between the limiting mechanism and the separator striping mechanism;

two separator separation mechanisms, two secondary cutting mechanisms and a positive electrode collecting mechanism are sequentially arranged between the separator striping mechanism and the film-drawing mechanism;

the two separator separation mechanisms are oppositely arranged along a vertical direction;

a lower one of the two separator separation mechanisms is fixed to the frame, and an upper one of the two separator separation mechanisms is fixed to the frame via a first lifting assembly;

the two secondary cutting mechanisms are oppositely arranged in the vertical direction; and;

a lower one of the two secondary cutting mechanisms is fixed to the frame, and an upper one of the two secondary cutting mechanisms is fixed to the frame via a second lifting assembly.

In some embodiments, the limiting mechanism comprises a material platform, a first Y-axis telescopic assembly, an X-axis telescopic assembly, a Y-axis limiting plate and an X-axis limiting plate; and the first Y-axis telescopic assembly, the X-axis telescopic assembly, the Y-axis limiting plate and the X-axis limiting plate are distributed on the material platform in a rectangular arrangement;

the material platform is provided with a sensing switch configured to detect whether the jelly roll is present within a rectangular region defined by the first Y-axis telescopic assembly, the X-axis telescopic assembly, the Y-axis limiting plate and the X-axis limiting plate;

the material platform is provided with a hole within the rectangular region;

the lifting mechanism comprises a third lifting assembly and a material pushing plate provided within the hole;

the third lifting assembly is located below the material platform, and is fixed to the material platform; and

the third lifting assembly is fixed to the material pushing plate.

In some embodiments, the primary cutting mechanism comprises a second Y-axis telescopic assembly and a first thermal cutting assembly;

the second Y-axis telescopic assembly is located below the material platform, and is fixed to the frame;

the second Y-axis telescopic assembly is fixed to a fourth lifting assembly, and the fourth lifting assembly is provided between the material platform and the separator striping mechanism;

the fourth lifting assembly is fixed to the first thermal cutting assembly; and

each of the two secondary cutting mechanisms comprises a second thermal cutting assembly.

In some embodiments, the unwinding mechanism comprises a Y-axis moving assembly fixed to the frame;

the Y-axis moving assembly comprises a moving plate, and the moving plate is fixedly provided with a third lifting assembly;

an X-axis moving assembly is provided below the Y-axis moving assembly, and is fixed to the third lifting assembly;

two clamping assemblies are oppositely arranged below the X-axis moving assembly along an X-axis direction; and

the two clamping assemblies are configured to open and close along the X-axis direction under the action of the X-axis moving assembly;

each of the two clamping assemblies comprises a servo motor and a transmission assembly fixed to the X-axis moving assembly;

the servo motor is fixed to the transmission assembly;

a main shaft of the servo motor is fixed to an input shaft of the transmission assembly; and

an output shaft of the transmission assembly is fixed to a clamping block.

In some embodiments, the negative electrode collecting mechanism comprises an electric roller and a Y-axis moving assembly;

the electric roller and the Y-axis moving assembly are fixedly connected to the frame;

a rotation axis of the electric roller is configured to extend along an X-axis direction;

the Y-axis moving assembly is rotatably connected to a driven roller, and the driven roller is arranged parallel to the electric roller; and

the driven roller is configured to move close to and away from the electric roller along a Y-axis direction under the action of the Y-axis moving assembly.

In some embodiments, the film-drawing mechanism comprises a Y-axis moving assembly fixed to the frame;

at least one first pneumatic gripper is fixedly arranged side by side on the Y-axis moving assembly;

the separator striping mechanism comprises a first base fixed to the frame;

a third lifting assembly is fixed below the first base;

a mounting plate is provided above the first base, and is fixed to the third lifting assembly;

a side of the mounting plate adjacent to the limiting mechanism is provided with a buffer plate and an air nozzle assembly;

at least one second pneumatic gripper is provided below the mounting plate;

the first base is fixedly provided with a fourth lifting assembly, and the fourth lifting assembly is arranged between the mounting plate and the limiting mechanism;

the fourth lifting assembly is fixedly provided with a separator stripping plate;

a side of the separator stripping plate adjacent to the limiting mechanism is rotatably provided with a transition roller;

a rotation axis of the transition roller is configured to extend along an X-axis direction; and

the separator stripping plate is provided with at least one avoidance notch respectively corresponding to the at least one first pneumatic gripper.

In some embodiments, the separator separation mechanism comprises a second base fixed to the frame or to the first lifting assembly;

a side of the second base away from a conveying surface is fixed to a fifth lifting assembly; wherein the conveying surface refers to a surface facing away from a remaining stacked structure in which a positive electrode is sandwiched between two separators clamped by the film-drawing mechanism;

a side of the second base adjacent to the conveying surface is provided with a separator suction assembly; and the separator suction assembly is fixed to the fifth lifting assembly, and is configured to extend along the X-axis direction;

the side of the second base adjacent to the conveying surface is fixed to a second Y-axis moving assembly;

a driven roller and an electric roller are respectively provided on two sides of the separator suction assembly;

the driven roller is rotatably connected to the second Y-axis moving assembly; and

the electric roller is fixed to the second base.

In some embodiments, the positive electrode collecting mechanism comprises a base plate fixed to the frame;

the base plate is provided with an X-axis moving assembly;

the X-axis moving assembly is fixed to a servo motor; and

a main shaft of the servo motor is fixed to a winding needle via a damper.

In some embodiments, a first pulling mechanism is provided between the separator striping mechanism and the separator separation mechanism, and a second pulling mechanism is provided between the positive electrode collecting mechanism and the film-drawing mechanism;

the first pulling mechanism and the second pulling mechanism each comprises a driven roller and an electric roller arranged in the vertical direction;

the driven roller is fixed to the frame via a third lifting assembly;

the electric roller is fixed to the frame; and

rotation axes of the driven roller and the electric roller are each configured to extend along an X-axis direction.

In a second aspect, this application provides a method for reverse separation and disassembly of jelly rolls, the method being performed based on the device described above, comprising:

(S100) placing the jelly roll on the limiting mechanism; and limiting, by the limiting mechanism, the jelly roll in X-axis and Y-axis directions;

(S200) cutting, by the primary cutting mechanism, the surface separator layer of the jelly roll limited by the limiting mechanism;

(S300) lifting, by the lifting mechanism, the jelly roll in the Z-axis direction;

(S400) gripping and transferring, by the unwinding mechanism, the jelly roll from the lifting mechanism to the separator stripping mechanism;

introducing air from the air source into the blowing brush through the pipeline, and blowing the air from the blowing brush toward the cut position of the surface separator layer of the jelly roll, so as to cause the end of the surface separator layer at the cut position to be separated; and

reversely rotating, by the unwinding mechanism, the jelly roll to unwind the jelly roll, such that a negative electrode end of the jelly roll falls into the negative electrode collecting mechanism by gravity, and a remaining stacked structure in which a positive electrode is sandwiched between two separators is suctioned and gripped by the separator striping mechanism;

(S500) clamping, by the film-drawing mechanism, the remaining stacked structure, followed by resetting, wherein during a resetting process, the remaining stacked structure passes through the two separator separation mechanisms, the two secondary cutting mechanisms, and the positive electrode collecting mechanism;

(S600) moving, by the second lifting assembly, the upper one of the two secondary cutting mechanisms downward to cooperate with lower one of the two secondary cutting mechanisms to clamp the remaining stacked structure, so as to cut the two separators on upper and lower surfaces of the positive electrode;

(S700) moving, by the first lifting assembly, the upper one of the two separator separation mechanisms downward, and actuating the two separator separation mechanisms to respectively separate the two separators on the upper and lower surfaces of the positive electrode; and

(S800) after the two separators are separated from the upper and lower surfaces of the positive electrode, winding the positive electrode by the positive electrode collecting mechanism, and releasing, by the film-drawing mechanism, the positive electrode during winding of the positive electrode.

Compared to the prior art, the present disclosure has the following beneficial effects.

Through close coordination among the various mechanisms, the device provided herein enables reverse precision separation and disassembly of spent stacked jelly rolls, that is, precisely separating the negative electrode, positive electrode, and separators of the stacked jelly roll in an almost intact manner. This replaces manual disassembly, improves the efficiency and safety of spent battery recycling, achieves automated disassembly of jelly rolls, reduces processing time, increases productivity, and provides a simple and compact device structure with a high degree of automation for separating the positive and negative electrodes and separators. The device provided herein is also suitable for precise disassembly of jelly rolls of different sizes.

### BRIEF DESCRIPTION OF THE DRAWINGS

FIG. 1 is a first perspective view of a device for reverse separation and disassembly of jelly rolls according to an embodiment of the present disclosure;

FIG. 2 is a second perspective view of the device according to an embodiment of the present disclosure;

FIG. 3 is a first perspective view of a limiting mechanism, a lifting mechanism and a primary cutting mechanism in a combined state according to an embodiment of the present disclosure;

FIG. 4 is a second perspective view of the limiting mechanism, the lifting mechanism and the primary cutting mechanism in the combined state according to an embodiment of the present disclosure;

FIG. 5 is a first perspective view of a separator striping mechanism according to an embodiment of the present disclosure;

FIG. 6 is a second perspective view of the separator striping mechanism according to an embodiment of the present disclosure;

FIG. 7 is a structural view of a film-drawing mechanism according to an embodiment of the present disclosure;

FIG. 8 is a first perspective view of an unwinding mechanism according to an embodiment of the present disclosure;

FIG. 9 is a second perspective view of the unwinding mechanism according to an embodiment of the present disclosure;

FIG. 10 is a structural view of the unwinding mechanism with a chain removed according to an embodiment of the present disclosure;

FIG. 11 is a structural view of a negative electrode collecting mechanism according to an embodiment of the present disclosure;

FIG. 12 is a first perspective view of a partial combination structure of the device according to an embodiment of the present disclosure;

FIG. 13 is a second perspective view of the partial combination structure of the device according to an embodiment of the present disclosure;

FIG. 14 is a structural view of a separator separation mechanism, a secondary cutting mechanism, a sixth lifting assembly and a seventh lifting assembly in a combined state according to an embodiment of the present disclosure; and

FIG. 15 is a structural view of a positive electrode collecting mechanism according to an embodiment of the present disclosure.

In the figures: 1-limiting mechanism; 110-material platform; 111-hole; 120-first Y-axis telescopic assembly; 130-X-axis telescopic assembly; 140-Y-axis limiting plate; 150-X-axis limiting plate; 2-separator striping mechanism; 210-first base; 220-first lifting assembly; 230-mounting plate; 240-buffer plate; 250-air nozzle assembly; 260-first pneumatic gripper; 261-first cylinder; 262-film-clamping jaw; 270-ninth lifting assembly; 280-separator stripping plate; 281-avoidance notch; 290-transition roller; 3-film-drawing mechanism; 310-first Y-axis moving assembly; 311-base frame; 312-first driving wheel; 313-first driven wheel; 314-first servo motor; 315-first synchronous belt; 316-first moving bracket; 317-first slide rail; 320-second pneumatic gripper; 4-lifting mechanism; 410-second lifting assembly; 420-material pushing plate; 5-primary cutting mechanism; 510-second Y-axis telescopic assembly; 520-first thermal cutting assembly; 530-third lifting assembly; 6-unwinding mechanism; 610-second Y-axis moving assembly; 611-second driving wheel; 612-second driven wheel; 613-second servo motor; 614-second synchronous belt; 615-moving plate; 616-second slide rail; 620-fourth lifting assembly; 630-first X-axis moving assembly; 631-driving sprocket; 632-driven sprocket; 633-chain; 634-first base plate; 635-fifth servo motor; 636-assembly block; 637-third slide rail; 640-clamping assembly; 641-third servo motor; 642-transmission assembly; 643-clamping block; 7-negative electrode collecting mechanism; 710-first electric roller; 720-third Y-axis moving assembly; 721-fourth slide rail; 722-second moving bracket; 723-first Y-axis cylinder; 730-first driven roller; 8-separator separation mechanism; 810-second base; 820-separator suction assembly; 830-second driven roller; 840-second electric roller; 850-fourth Y-axis moving assembly; 851-second Y-axis cylinder; 852-fifth slide rail; 853-third moving bracket; 860-fifth lifting assembly; 9-secondary cutting mechanism; 10-positive electrode collecting mechanism; 1010-second base plate; 1020-second X-axis moving assembly; 1021-third base plate; 1022-first X-axis cylinder; 1023-sixth slide rail; 1030-fourth servo motor; 1040-damper; 1050-winding mandrel; 11-sixth lifting assembly; 12-seventh lifting assembly; 13-pulling mechanism; 1310-third driven roller; 1320-third electric roller; 1330-eighth lifting assembly; and 14-frame.

### DETAILED DESCRIPTION OF EMBODIMENTS

The principles and features of the present disclosure are described below with reference to the accompanying drawings. The embodiments are merely illustrative, and are not intended to limit the scope of the present disclosure.

### EXAMPLE 1

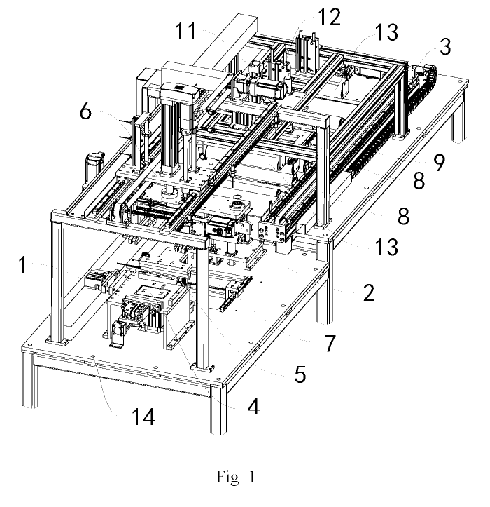

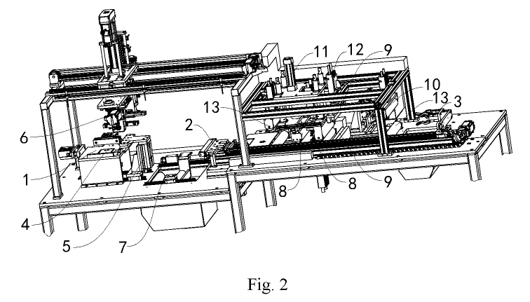

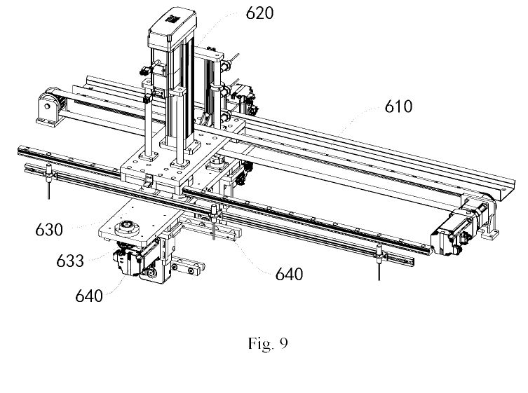

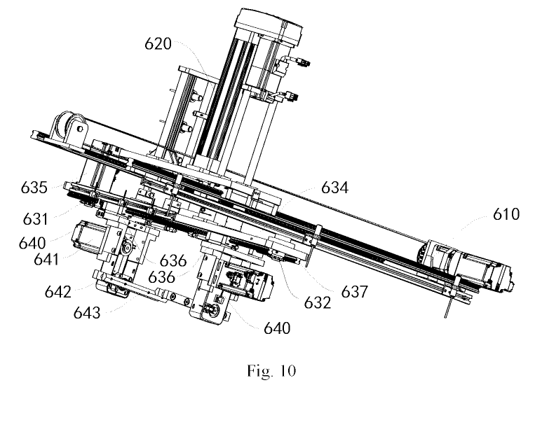

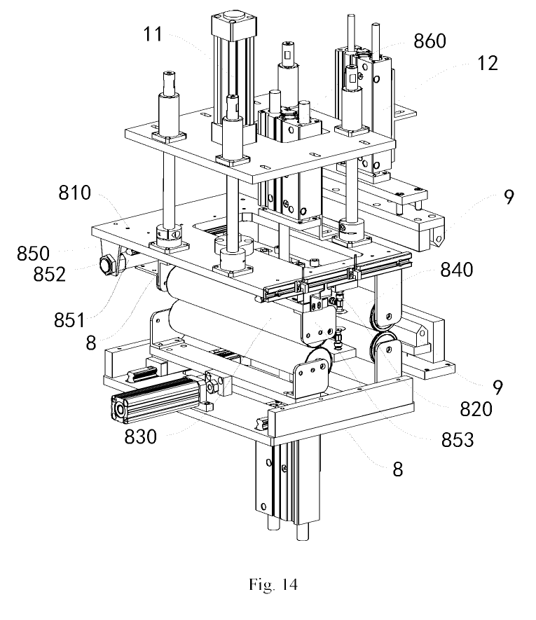

As shown in FIGS. 1-15, the present disclosure provides a device for reverse separation and disassembly of jelly rolls, including a frame 14, a limiting mechanism 1, a separator striping mechanism 2 and a film-drawing mechanism 3. The limiting mechanism 1, the separator striping mechanism 2 and the film-drawing mechanism 3 are sequentially fixedly provided on the frame 14 along a flow direction of a jelly roll. A to-be-separated-and-disassembled jelly roll is placed on the limiting mechanism 1. The limiting mechanism 1 is configured to limit the to-be-separated-and-disassembled jelly roll in X-axis and Y-axis directions, such that the to-be-separated-and-disassembled jelly roll is held at a predetermined position without movement, thereby preparing the jelly roll for subsequent primary separator cutting and gripping.

The frame 14 is provided with a primary cutting mechanism 5. The primary cutting mechanism 5 is configured to cut a surface separator layer of the jelly roll limited by the limiting mechanism 1. Since an outer end of the surface separator layer of the jelly roll is thermally bonded to other regions thereof after the negative and positive electrodes are wound into the jelly roll, the outer end must be cut in order to allow subsequent separation and disassembly of the cell roll by unwinding. The primary cutting mechanism 5 is configured to cut only the surface separator layer of the jelly roll without simultaneously cutting the negative electrode.

The frame 14 is provided with a lifting mechanism 4. The lifting mechanism 4 is configured to lift the jelly roll limited by the limiting mechanism 1 in a Z-axis direction. The lifting operation is performed only after the primary cutting mechanism 5 has completed cutting the surface separator layer of the jelly roll limited by the limiting mechanism 1.

The frame 14 is provided with an unwinding mechanism 6. The unwinding mechanism 6 is configured to grip and transfer the jelly roll lifted by the lifting mechanism 4 to the separator striping mechanism 2.

The unwinding mechanism 6 is provided with a blowing brush connected to an air source via a pipeline. An airflow from the air source flows through the pipeline into the blowing brush and then discharged therefrom. The airflow is directed toward a cut position at the surface separator layer of the jelly roll gripped by the unwinding mechanism 6, so as to cause an end of the surface separator layer at the cut position to be separated and gripped by the separator stripping mechanism 2. The separator striping mechanism 2 performs a suction-then-gripping operation. After the end of the surface separator layer at the cut position is separated and gripped by the separator striping mechanism 2, the unwinding mechanism 6 is configured to unwind the jelly roll.

The frame 14 is further provided with a negative electrode collecting mechanism 7 between the limiting mechanism 1 and the separator striping mechanism 2. Two separator separation mechanisms 8, two secondary cutting mechanisms 9 and a positive electrode collecting mechanism 10 are sequentially arranged between the separator striping mechanism 2 and the film-drawing mechanism 3.

The two separator separation mechanisms 8 are oppositely arranged along a vertical direction. A lower one of the two separator separation mechanisms 8 is fixed to the frame 14, and an upper one of the two separator separation mechanisms 8 is fixed to the frame 14 via a sixth lifting assembly 11.

The two secondary cutting mechanisms 9 are oppositely arranged in the vertical direction. A lower one of the two secondary cutting mechanisms 9 is fixed to the frame 14, and an upper one of the two secondary cutting mechanisms 9 is fixed to the frame 14 via a seventh lifting assembly 12.

The limiting mechanism 1, the separator striping mechanism 2, the film-drawing mechanism 3, the lifting mechanism 4, the primary cutting mechanism 5, the unwinding mechanism 6, the negative electrode collecting mechanism 7, the separator separation mechanisms 8, the secondary cutting mechanisms 9, the positive electrode collecting mechanism 10, the sixth lifting assembly 11, and the seventh lifting assembly 12 are respectively electrically connected to a controller, such that the controller controls operations of the limiting mechanism 1, the separator striping mechanism 2, the film-drawing mechanism 3, the lifting mechanism 4, the primary cutting mechanism 5, the unwinding mechanism 6, the negative electrode collecting mechanism 7, the separator separation mechanisms 8, the secondary cutting mechanisms 9, the positive electrode collecting mechanism 10, the sixth lifting assembly 11 and the seventh lifting assembly 12, respectively.

The present disclosure also provides a method for reverse separation and disassembly of jelly roll based on the above device, including the following steps.

(S100) The jelly roll is placed on the limiting mechanism 1 and the jelly roll is limited by the limiting mechanism 1 in X-axis and Y-axis directions.

(S200) The surface separator layer of the jelly roll limited by the limiting mechanism 1 is cut by the primary cutting mechanism 5.

(S300) The jelly roll is lifted by the lifting mechanism 4 in the Z-axis direction.

(S400) The jelly roll is gripped and transferred by the unwinding mechanism 6 from the lifting mechanism 4 to the separator stripping mechanism 2. Air is introduced from the air source into the blowing brush through the pipeline, and the air is blown form the blowing brush toward the cut position of the surface separator layer of the jelly roll, so as to cause the end of the surface separator layer at the cut position to be separated. The jelly roll is reversely rotated by the unwinding mechanism 6 to unwind the jelly roll (typically for two to three turns), such that a negative electrode end of the jelly roll falls into the negative electrode collecting mechanism 7 by gravity, and a remaining stacked structure in which a positive electrode is sandwiched between two separators is suctioned and gripped by the separator striping mechanism 2.

(S500) The remaining stacked structure is clamped by the film-drawing mechanism 3 and is reset, where during a resetting process, the remaining stacked structure passes through the two separator separation mechanisms 8, the two secondary cutting mechanisms 9 and the positive electrode collecting mechanism 10.

(S600) The upper one of the two secondary cutting mechanisms 9 is moved downward by the seventh lifting assembly 12 to cooperate with the lower one of the two secondary cutting mechanisms 9 to clamp the remaining stacked structure, so as to cut the two separators on upper and lower surfaces of the positive electrode, where the two secondary cutting mechanisms 9 are configured to cut only the two separators on the upper and lower surfaces of the positive electrode without cutting the positive electrode.

(S700) The upper one of the two separator separation mechanisms 8 is moved downward by the sixth lifting assembly 11, and the two separator separation mechanisms 8 are actuated to respectively separate the two separators on the upper and lower surfaces of the positive electrode.

(S800) After the two separators are separated from the upper and lower surfaces of the positive electrode, the positive electrode is wound by the positive electrode collecting mechanism 10, and the positive electrode is released by the film-drawing mechanism 3 during winding of the positive electrode.

### EXAMPLE 2

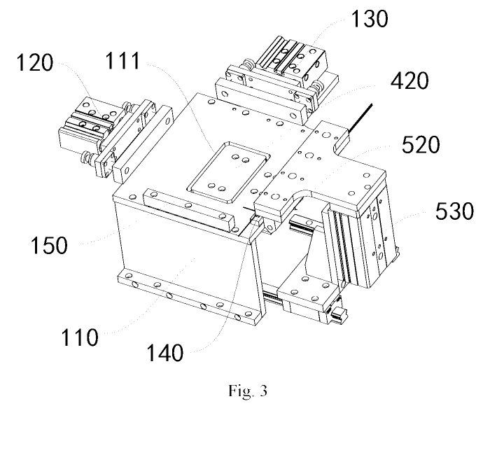

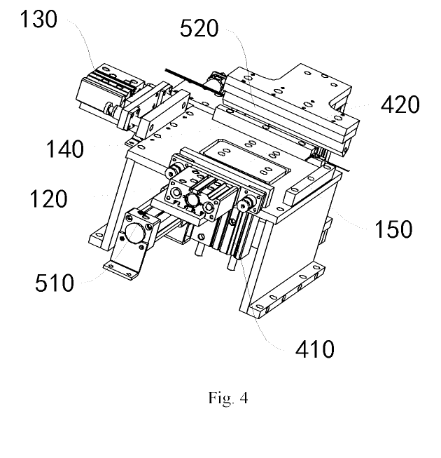

As shown in FIGS. 3 and 4, the present embodiment provides further improvements based on Example 1, which are described as follows.

The limiting mechanism 1 includes a material platform 110, a first Y-axis telescopic assembly 120, an X-axis telescopic assembly 130, a Y-axis limiting plate 140 and an X-axis limiting plate 150. The first Y-axis telescopic assembly 120, the X-axis telescopic assembly 130, the Y-axis limiting plate 140 and the X-axis limiting plate 150 are distributed on the material platform 110 in a rectangular configuration. The Y-axis direction is defined as the flow direction of the jelly roll. The material platform 110 is provided with a sensing switch configured to detect whether the jelly roll is present within a rectangular region defined by the first Y-axis telescopic assembly 120, the X-axis telescopic assembly 130, the Y-axis limiting plate 140 and the X-axis limiting plate 150. When the sensing switch detects the presence of the jelly roll, a sensing signal is transmitted to a controller. The controller controls the first Y-axis telescopic assembly 120 and the X-axis telescopic assembly 130 to operate, such that the first Y-axis telescopic assembly 120 cooperates with the Y-axis limiting plate 140 to constrain the jelly roll in the Y-axis direction, and the X-axis telescopic assembly 130 cooperates with the X-axis limiting plate 150 to constrain the jelly roll in the X-axis direction. The material platform 110 is provided with a hole 111 within the rectangular region. A size of the hole 111 is smaller than a size of the jelly roll, such that the jelly roll does not fall through the hole 111.

The lifting mechanism 4 includes a second lifting assembly 410 and a material pushing plate 420. The material pushing plate 420 is provided within the hole 111. A cross-sectional size of the material pushing plate 420 is smaller than that of the hole 111. The second lifting assembly 410 is provided below the material platform 110, and is fixed to the material platform 110. The second lifting assembly 410 is fixed to the material pushing plate 420. In this embodiment, the first Y-axis telescopic assembly 120, the X-axis telescopic assembly 130 and the second lifting assembly 410 may each be implemented as a cylinder commonly used in the prior art, such as a pneumatic cylinder. This is merely an exemplary description. In practical applications, an electric cylinder or a hydraulic cylinder may also be used.

### EXAMPLE 3

As shown in FIGS. 3-4, this embodiment provides a further improvement based on Example 2, which are described as follows.

The primary cutting mechanism 5 includes a second Y-axis telescopic assembly 510 and a first thermal cutting assembly 520. The second Y-axis telescopic assembly 510 is located below the material platform 110, and is fixed to the frame 14. The material platform 110 may have an n-shaped structure, or alternatively an inverted L-shaped structure, without limiting the present disclosure to a specific shape. The second Y-axis telescopic assembly 510 is fixed to a third lifting assembly 530, and the third lifting assembly 530 is located between the material platform 110 and the separator striping mechanism 2. The third lifting assembly 530 is fixed to the first thermal cutting assembly 520. The first thermal cutting assembly 520 is provided above the jelly roll on the material platform 110. The first thermal cutting assembly 520 is configured to cut the separator using a hot knife. When the hot knife reaches a predetermined temperature range, the separator can typically be cut within approximately five seconds.

The second Y-axis telescopic assembly 510 and the third lifting assembly 530 may each use a conventional cylinder commonly known in the prior art, such as a pneumatic cylinder. This is merely an illustrative example. In practical applications, the electric cylinder or the hydraulic cylinder may also be used.

After the limiting mechanism 1 completes limiting the jelly roll in the X-axis and Y-axis directions, the second Y-axis telescopic assembly 510 is actuated to control the third lifting assembly 530 and the first thermal cutting assembly 520 to move close to the jelly roll along the Y-axis direction. After reaching a predetermined position, which can be determined by conventional photoelectric switches or sensing plates within the travel range (the same method is applied in other similar steps described later), the second Y-axis telescopic assembly 510 stops. The third lifting assembly 530 then lowers the first thermal cutting assembly 520 to perform a primary thermal cutting on the surface separator layer of the jelly roll, thereby separating the outer end portion of the surface separator layer.

The working principle of the first thermal cutting assembly 520 is as follows: the hot knife is energized to reach a sufficient temperature, such that an outer end portion of the surface separator layer of the jelly roll can be cut. After the cutting operation is completed, the first thermal cutting assembly 520 is returned to its initial position under the control of the second Y-axis telescopic assembly 510 and the third lifting assembly 530.

In some embodiments, the secondary cutting mechanism 9 includes a second thermal cutting assembly, having the same working principle as the first thermal cutting assembly 520. In this embodiment, “primary cutting” and “secondary cutting” refer to the first and second cutting operations performed on the separator, respectively.

### EXAMPLE 4

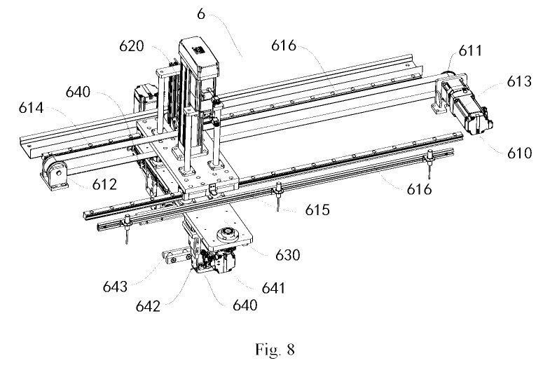

As shown in FIGS. 8-10, this embodiment provides a further improvement based on any one of Examples 1 to 3, which are described as follows.

The unwinding mechanism 6 includes a second Y-axis moving assembly 610, which is fixed to the frame 14. The second Y-axis moving assembly 610 includes a moving plate 615, and the moving plate 615 is fixedly provided with a fourth lifting assembly 620. A first X-axis moving assembly 630 is provided below the second Y-axis moving assembly 610, and is fixed to the fourth lifting assembly 620. Two clamping assemblies 640 are oppositely arranged below the first X-axis moving assembly 630 along the X-axis direction . The two clamping assemblies 640 have identical structures. Under the action of the first X-axis moving assembly 630, the two clamping assemblies 640 are configured to open and close along the X-axis direction, that is, to move close to each other and away from each other along the X-axis direction, where movement close to each other corresponds to a closing operation, and movement away from each other corresponds to an opening operation.

Each clamping assembly 640 includes a third servo motor 641 and a transmission assembly 642 fixed to the first X-axis moving assembly 630. The third servo motor 641 is fixed to the transmission assembly 642. A main shaft of the third servo motor 641 is fixed to an input shaft of the transmission assembly 642. An output shaft of the transmission assembly 642 is fixed to a clamping block 643. When the third servo motor 641 is actuated, the third servo motor 641 drives the clamping block 643 to rotate via the transmission assembly 642. A rotation axis of the clamping block 643 is configured to extend along the X-axis direction. The transmission assembly 642 includes a housing and a transmission chain within the housing, which may be implemented as a sprocket drive, gear drive or pulley drive.

The working principle of the unwinding mechanism 6 is as follows. After the surface separator layer of the jelly roll is cut, the second Y-axis moving assembly 610 is actuated to control the fourth lifting assembly 620, the first X-axis moving assembly 630 and the two clamping assemblies 640 to move along the Y-axis direction close to the limiting mechanism 1. Upon reaching a predetermined position, the second Y-axis moving assembly 610 stops. The fourth lifting assembly 620 is then actuated to lower the first X-axis moving assembly 630 and the two clamping assemblies 640 along the Z-axis direction until reaching a predetermined position, after which the fourth lifting assembly 620 stops. The first X-axis moving assembly 630 is then actuated to control the two clamping assemblies 640 to move close to each other along the X-axis direction to clamp the jelly roll on the lifting mechanism 4. After clamping, the fourth lifting assembly 620 controls the first X-axis moving assembly 630, the two clamping assemblies 640 and the jelly roll to move upward, and to coordinate with the second Y-axis moving assembly 610 to transfer the jelly roll to a predetermined position. Subsequently, an airflow from the air source is introduced into the blowing brush via the pipeline and discharged through the blowing brush. The airflow is directed toward the cut position of the surface separator layer of the jelly roll gripped by the unwinding mechanism, so as to cause an end of the surface separator layer at the cut position to be separated. The jelly roll is then rotated in reverse (typically two to three turns) to unwind the roll, allowing the negative electrode end to fall into the negative electrode collecting mechanism 7 by gravity, while the remaining stacked structure in which a positive electrode is sandwiched between two separators is suctioned and gripped by the separator striping mechanism 2.

The second Y-axis moving assembly 610 may be implemented as a pneumatic cylinder, an electric cylinder or a hydraulic cylinder. Alternatively, the second Y-axis moving assembly 610 may include a second driving wheel 611, a second driven wheel 612, a second servo motor 613, a second synchronous belt 614, the moving plate 615, and two second slide rails 616. The second driving wheel 611 and the second driven wheel 612 are respectively rotatably fixed to the frame 14. The second synchronous belt 614 is looped around the second driving wheel 611 and the second driven wheel 612. The second servo motor 613 is fixed to the frame 14. A main shaft of the second servo motor 613 is fixedly connected to the second driving wheel 611. The two second slide rails 616 are provided on two side of the second synchronous belt 614, and are fixed to the frame 14. Two ends of the moving plate 615 are respectively connected to sliders on the two second slide rails 616. The moving plate 615 is connected to a portion of the second synchronous belt 614. When the second servo motor 613 is actuated, the second servo motor 613 controls the rotation of the second driving wheel 611, which in turn drives the second driven wheel 612 to rotate via the second synchronous belt 614, thereby causing the moving plate 615 to move along the Y-axis direction following the second synchronous belt 614.

The first X-axis moving assembly 630 may be implemented as a common dual-slider lead screw module. Alternatively, the first X-axis moving assembly 630 may include a driving sprocket 631, a driven sprocket 632, a chain 633, a first base plate 634, a fifth servo motor 635, two assembly blocks 636 and two third slide rails 637. The first base plate 634 is fixed to the fourth lifting assembly 620. The driving sprocket 631 and the driven sprocket 632 are respectively rotatably provided below the first base plate 634. Rotation axes of the driving sprocket 631 and the driven sprocket 632 are configured to extend along the Z-axis direction. The chain 633 is looped around the driving sprocket 631 and the driven sprocket 632. The two third slide rails 637 are respectively arranged on two sides of the chain 633 along the X-axis direction, and are fixed to the first base plate 634. Two ends of each assembly block 636 are respectively fixedly connected to sliders on the two third slide rails 637. The clamping assembly 640 is fixed beneath each assembly block 636. One of the two assembly blocks 636 is connected to a first side of the chain 633, and the other of the two assembly blocks 636 is connected to a second side of the chain 633. The fifth servo motor 635 is fixed on the first base plate 634. A main shaft of the fifth servo motor 635 is fixedly connected to the driving sprocket 631. When the fifth servo motor 635 is actuated, the fifth servo motor 635 controls the rotation of the driving sprocket 631, which in turn drives the driven sprocket 632 to rotate via the chain 633. The two assembly blocks 636 are respectively connected to two sides of the chain 633, such that the two assembly blocks 636 move close to and away from each other through the chain 633. This movement allows the two clamping assemblies 640 to move close to and away from each other accordingly.

### EXAMPLE 5

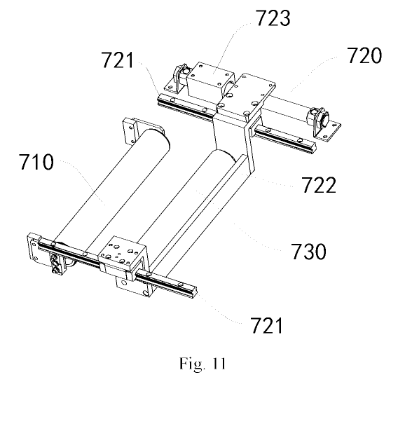

As shown in FIG. 11, this embodiment provides a further improvement based on any one of Examples 1 to 4, which are described as follows.

The negative electrode collecting mechanism 7 includes a first electric roller 710 and a third Y-axis moving assembly 720. The first electric roller 710 and the third Y-axis moving assembly 720 are fixedly connected to the frame 14. A rotation axis of the first electric roller 710 is configured to extend along the X-axis direction. The third Y-axis moving assembly 720 is rotatably connected to a first driven roller 730, and the first driven roller 730 is parallel to the first electric roller 710. The first driven roller 730 is configured to move close to and away from the first electric roller 710 along the Y-axis direction under the action of the third Y-axis moving assembly 720.

The working principle of the negative electrode collecting mechanism 7 is as follows. For the negative electrode released from the jelly roll by the unwinding mechanism 6, when the negative electrode end falls into a space between the first electric roller 710 and the first driven roller 730 by gravity, the third Y-axis moving assembly 720 is actuated to control the first driven roller 730 to move close to the first electric roller 710 along the Y-axis direction. The first driven roller 730 cooperates with the first electric roller 710 to clamp the negative electrode, while the first electric roller 710 is actuated to pull the negative electrode.

In this embodiment, the third Y-axis moving assembly 720 may include at least one pneumatic cylinder, electric cylinder or hydraulic cylinder. Alternatively, the third Y-axis moving assembly 720 may include two fourth slide rails 721, a second moving bracket 722 and a first Y-axis cylinder 723. The two fourth slide rails 721 are respectively fixed to the frame 14, and are distributed along the Y-axis direction. Two ends of the second moving bracket 722 are respectively fixed to sliders on the two fourth slide rails 721. Two ends of the first driven roller 730 are rotatably connected to the second moving bracket 722. The first Y-axis cylinder 723 is fixed to the frame 14. A piston rod of the first Y-axis cylinder 723 is connected to the second moving bracket 722. When the first Y-axis cylinder 723 is actuated, the first Y-axis cylinder 723 controls the second moving bracket 722 to reciprocate along the fourth slide rails 721, thereby moving the first driven roller 730 close to and away from the first electric roller 710 along the Y-axis direction.

### EXAMPLE 6

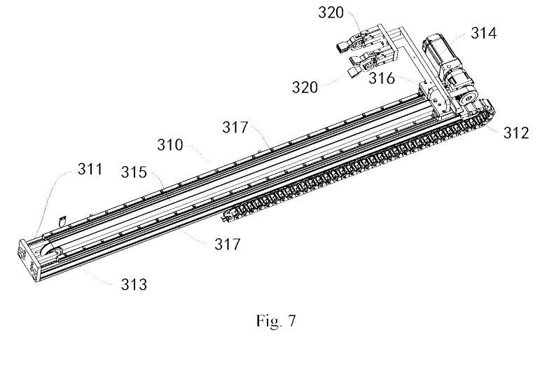

As shown in FIG. 7, this embodiment provides a further improvement based on any one of Examples 1 to 5, which are described as follows.

The film-drawing mechanism 3 includes a first Y-axis moving assembly 310 fixed to the frame 14. At least one second pneumatic gripper 320 is fixedly arranged side by side on the first Y-axis moving assembly 310. As shown in the FIG. 7, two second pneumatic grippers 320 are provided. One of the two second pneumatic grippers 320 is in an open state, and the other of the two second pneumatic grippers 320 is in a closed state. Each of the two second pneumatic grippers 320 is configured to open and close.

The first Y-axis moving assembly 310 may include a pneumatic cylinder, an electric cylinder or a hydraulic cylinder. Alternatively, the first Y-axis moving assembly 310 may include a base frame 311, a first driving wheel 312, a first driven wheel 313, a first servo motor 314, a first synchronous belt 315, a first moving bracket 316 and two first slide rails 317. The base frame 311 is fixed to the frame 14 along the Y-axis direction. The first driving wheel 312 is rotatably mounted on the base frame 311. A rotation axis of the first driving wheel 312 is configured to extend along the X-axis direction. The first driven wheel 313 is rotatably mounted on the base frame 311. A rotation axis of the first driven wheel 313 is configured to extend along the X-axis direction. The first servo motor 314 is fixed to the base frame 311. A main shaft of the first servo motor 314 is fixedly connected to the first driving wheel 312. The first synchronous belt 315 is looped around the first driving wheel 312 and the first driven wheel 313. The first synchronous belt 315 is configured to extend from a position adjacent to the separator striping mechanism 2 to a position beyond the positive electrode collecting mechanism 10. A first end of the first moving bracket 316 is connected to the first synchronous belt 315, and the at least one second pneumatic gripper 320 is fixed at a second end of the first moving bracket 316 in a side-by-side arrangement. The two first slide rails 317 are fixedly arranged on the base frame 311 in parallel along the Y-axis direction. The first moving bracket 316 is fixed to sliders on the two first slide rails 317.

The second pneumatic gripper 320 may be implemented as a finger cylinder with two film pulling jaws, where the two film pulling jaws are respectively fixed to two fingers of the finger cylinder.

When the first servo motor 314 is actuated, the first servo motor 314 drives the first driving wheel 312 to rotate, which in turn drives the first driven wheel 313 to rotate via the first synchronous belt 315, thereby causing the first moving bracket 316, which is fixed to the first synchronous belt 315, to move along the Y-axis direction. The second pneumatic grippers 320 move synchronously with the first moving bracket 316. After the second pneumatic grippers 320 reach a predetermined position, the first servo motor 314 stops, and the second pneumatic grippers 320 are actuated to grip the remaining stacked structure in which a positive electrode is sandwiched between two separators, which is held by the separator striping mechanism 2. The first servo motor 314 is then driven to rotate in a reverse direction, thereby causing the second pneumatic grippers 320 to reset while gripping the the remaining stacked structure.

### EXAMPLE 7

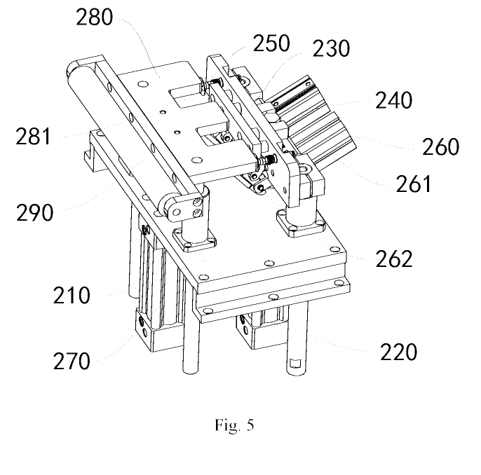

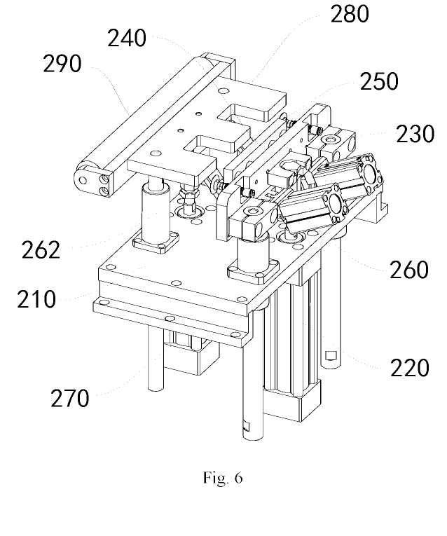

As shown in FIGS. 5 and 6, this embodiment provides a further improvement based on Example 6, which are described as follows.

The separator striping mechanism 2 includes a first base 210 fixed to the frame 14. A first lifting assembly 220 is fixed below the first base 210. A mounting plate 230 is arranged above the first base 210, and is fixed to the first lifting assembly 220. The first lifting assembly 220 is configured to control the mounting plate 230 to move up and down along the Z-axis direction. A side of the mounting plate 230 adjacent to the limiting mechanism 1 is provided with a buffer plate 240 and an air nozzle assembly 250. At least one first pneumatic gripper 260 is provided below the mounting plate 230.

The first pneumatic gripper 260 may include a first cylinder 261 and a film-clamping jaw 262. A cylinder body of the first cylinder 261 is rotatably connected to the mounting plate 230. The first cylinder 261 is configured to rotate about a rotation axis of the mounting plate 230, with the rotation axis extending in the X-axis direction. A middle portion of the film-clamping jaw 262 is rotatably connected to the mounting plate 230. The film-clamping jaw 262 is configured to rotate about the rotation axis of the mounting plate 230, with the rotation axis extending in the X-axis direction. A lower end of the film-clamping jaw 262 is rotatably connected to a piston rod of the first cylinder 261. The film-clamping jaw 262 is configured to rotate about a rotation axis of the first cylinder 261, with the rotation axis extending in the X-axis direction. The first cylinder 261 is configured to control an upper end of the film-clamping jaw 262 to move close to and away from the buffer plate 240 through extension and retraction. When moving close to the buffer plate 240, the upper end of the film-clamping jaw 262 cooperates with the buffer plate 240 to clamp the remaining stacked structure, and the buffer plate 240 is further configured to provide impact buffering.

The first base 210 is fixedly provided with a ninth lifting assembly 270, and the ninth lifting assembly 270 is arranged between the mounting plate 230 and the limiting mechanism 1. The ninth lifting assembly 270 is fixedly provided with a separator stripping plate 280. A side of the separator stripping plate 280 adjacent to the limiting mechanism 1 is rotatably provided with a transition roller 290. A rotation axis of the transition roller 290 is configured to extend along the X-axis direction. The ninth lifting assembly 270 is configured to control the separator stripping plate 280 and the transition roller 290 to move up and down along the Z-axis direction. The separator stripping plate 280 is provided with at least one avoidance notch 281 respectively corresponding to each second pneumatic gripper 320. The avoidance notch 281 is configured to avoid interference with the film pulling jaws of the second pneumatic grippers 320.

The working principle of the separator striping mechanism 2 is as follows. The first lifting assembly 220 is actuated to control the mounting plate 230, the air nozzle assembly 250 and the first pneumatic gripper 260 to move upward along the Z-axis direction. The air nozzle assembly 250 then performs suction to draw the remaining stacked structure toward the air nozzle assembly 250 and hold the remaining stacked structure by suction. The first pneumatic gripper 260 is actuated to cooperate with the buffer plate 240 to clamp the remaining stacked structure.

The ninth lifting assembly 270 is then actuated to control the separator stripping plate 280 and the transition roller 290 to move upward along the Z-axis direction. After reaching a predetermined position, the ninth lifting assembly 270 stops. The first Y-axis moving assembly 310 of the film-drawing mechanism 3 is then actuated to control the second pneumatic grippers 320 to move toward the separator striping mechanism 2 along the Y-axis direction. After reaching a predetermined position, the first Y-axis moving assembly 310 stops, and the second pneumatic grippers 320 are actuated to clamp the remaining stacked structure. The first Y-axis moving assembly 310 then controls the second pneumatic grippers 320 to reset while holding the remaining stacked structure.

### EXAMPLE 8

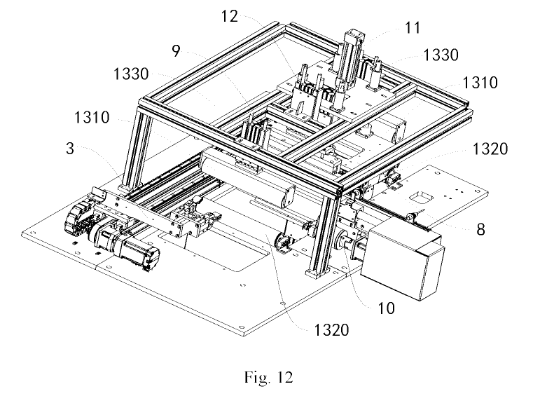

As shown in FIGS. 12-14, this embodiment is a further improvement based on any one of Examples 1-7, which are described as follows.

The separator separation mechanism 8 includes a second base 810. For the lower one of the two separator separation mechanisms 8, the second base 810 is fixed to the frame 14. For the upper one of the two separator separation mechanisms 8, the second base 810 is fixed to the sixth lifting assembly 11. A side of the second base 810 away from a conveying surface is fixed to a fifth lifting assembly 860 (i.e., the conveying surface refers to a surface facing away from the remaining stacked structure clamped by the film-drawing mechanism 3). A side of the second base 810 adjacent to the conveying surface is provided with a separator suction assembly 820, and the separator suction assembly 820 is fixed to the fifth lifting assembly 860, and is configured to extend along the X-axis direction. The side of the second base 810 adjacent to the conveying surface is fixed to a fourth Y-axis moving assembly 850. A second driven roller 830 and a second electric roller 840 are respectively provided on two sides of the separator suction assembly 820. The second driven roller 830 is rotatably connected to the fourth Y-axis moving assembly 850. The fourth Y-axis moving assembly 850 is configured to control the second driven roller 830 to move close to and away from the second electric roller 840. The second electric roller 840 is fixed to the second base 810. The fifth lifting assembly 860 may employ a conventional cylinder, such as a pneumatic cylinder. This is merely an exemplary illustration, and in practical applications, an electric cylinder or a hydraulic cylinder may also be used.

The fourth Y-axis moving assembly 850 may employ a conventional cylinder, such as a pneumatic cylinder. This is merely an exemplary illustration, and in practical applications, an electric cylinder or a hydraulic cylinder may also be used. Alternatively, the fourth Y-axis moving assembly 850 may include a second Y-axis cylinder 851, a fifth slide rail 852 and a third moving bracket 853. The second Y-axis cylinder 851 and the fifth slide rail 852 are fixed to the second base 810. A first end of the third moving bracket 853 is fixed to a piston rod of the second Y-axis cylinder 851, and a second end of the third moving bracket 853 is fixed to a slider on the fifth slide rail 852. The second Y-axis cylinder 851 controls the third moving bracket 853 to move along the fifth slide rail 852 in the Y-axis direction through extension and retraction, thereby driving the second driven roller 830 to move close to and away from the second electric roller 840.

The working principle of the separator separation mechanism 8 is as follows.

After the second pneumatic grippers 320 of the film-drawing mechanism 3 reset while holding the remaining stacked structure, the two secondary cutting mechanisms 9 are respectively positioned above and below the remaining stacked structure. Similarly, the two separator separation mechanisms 8 are respectively positioned above and below the remaining stacked structure. The seventh lifting assembly 12 controls the upper one of the two secondary cutting mechanisms 9 to move downward to cooperate with the lower one of the two secondary cutting mechanisms 9, thereby clamping the remaining stacked structure and cutting the two separators on the upper and lower surfaces of the positive electrode. Next, the sixth lifting assembly 11 is actuated to control the upper one of the two separator separation mechanisms 8 to move downward. After reaching the predetermined position, the sixth lifting assembly 11 stops. The second driven rollers 830 of the two separator separation mechanisms 8 cooperate to clamp the positive electrode, and the second electric rollers 840 also cooperate to hold the positive electrode, thereby preventing breakage of the positive electrode during the separation and disassembly process..

The fifth lifting assembly 860 of the upper one of the two separator separation mechanisms 8 is then actuated to control an upper one of the separator suction assemblies 820 to move downward, and the fifth lifting assembly 860 of the lower one of the two separator separation mechanisms 8 is actuated to control a lower one of the separator suction assemblies 820 to move upward. The two separator suction assemblies 820 start to operate and suction the separators on the upper and lower surfaces of the positive electrode, respectively. After the separators are suctioned, the fifth lifting assemblies 860 control the separator suction assemblies 820 to reset while holding the separators, respectively.

Finally, the fourth Y-axis moving assembly 850 of the separator separation mechanism 8 is actuated to control the second driven roller 830 to move close to the second electric roller 840, such that the second driven roller 830 cooperates with the second electric roller 840 to clamp the separators suctioned by the separatorsuction assemblies 820. The second electric roller 840 is then started to wind the separators onto itself.

### EXAMPLE 9

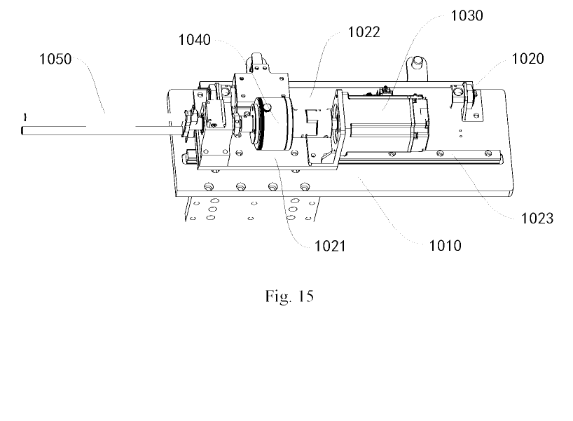

As shown in FIG. 15, this embodiment represents a further improvement based on any one of Examples 1 to 8, which are described as follows.

The positive electrode collecting mechanism 10 includes a second base plate 1010 fixed to the frame 14. The second base plate 1010 is provided with a second X-axis moving assembly 1020, and the second X-axis moving assembly 1020 isfixed to a fourth servo motor 1030. A main shaft of the fourth servo motor 1030 is fixed to a winding needle 1050 via a damper 1040. The second X-axis moving assembly 1020 is configured to control the fourth servo motor 1030, the damper 1040 and the winding needle 1050 to move along the X-axis direction. After the separators on the upper and lower surfaces of the positive electrode are separated by the separator separating mechanisms 8, the second X-axis moving assembly 1020 is actuated to control the winding needle 1050 to move along the X-axis direction, allowing the positive electrode to be inserted into the winding needle 1050. The fourth servo motor 1030 is then actuated and the winding needle 1050 is rotated via the damper 1040, thereby winding the positive electrode onto the winding needle 1050.

The second X-axis moving assembly 1020 may employ a conventional cylinder, such as a pneumatic cylinder. This is merely an exemplary illustration, and in practical applications, an electric cylinder or a hydraulic cylinder may also be used. Alternatively, the second X-axis moving assembly 1020 includes a third base plate 1021, a first X-axis cylinder 1022 and a sixth slide rail 1023. The first X-axis cylinder 1022 and the sixth slide rail 1023 are fixed to the second base plate 1010. The third base plate 1021 is fixed on a slider on the sixth slide rail 1023. A piston rod of the first X-axis cylinder 1022 is fixedly connected to the third base plate 1021. The fourth servo motor 1030 is fixed on the third base plate 1021. When the first X-axis cylinder 1022 is actuated, the third base plate 1021 is driven to move along the sixth slide rail 1023 in the X-axis direction, thereby driving the fourth servo motor 1030, the damper 1040 and the winding needle 1050 to move along the X-axis direction.

### EXAMPLE 10

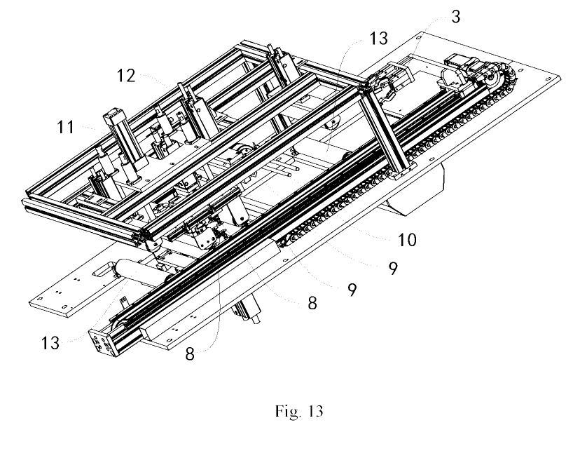

As shown in FIGS. 12-13, this embodiment represents a further improvement based on any one of Examples 1 to 9, which are described as follows.

A first pulling mechanism 13 is provided between the separator striping mechanism 2 and the separator separating mechanism 8, and a second pulling mechanism 13 is provided between the positive electrode collecting mechanism 10 and the film-drawing mechanism 3. The first pulling mechanism 13 and the second pulling mechanism 13 each includes a third driven roller 1310 and a third electric roller 1320 arranged in the vertical direction. The third driven roller 1310 is fixed to the frame 14 via an eighth lifting assembly 1330. The third electric roller 1320 is fixed to the frame 14. Rotation axes of the third driven roller 1310 and the third electric roller 1320 are each configured to extend along the X-axis direction. After the second pneumatic gripper 320 of the film-drawing mechanism 3 resets while gripping the remaining stacked structure, the eighth lifting assembly 1330 is actuated to control the third driven roller 1310 to move downward, thereby cooperating with the third electric roller 1320 to clamp the remaining stacked structure. The pulling mechanisms 13 can not only transfer the remaining stacked structure, but also prevent breakage of the positive electrode during the separation and disassembly process. The eighth lifting assembly 1330 may employ a conventional cylinder, such as a pneumatic cylinder. This is merely an exemplary illustration, and in practical applications, an electric cylinder or a hydraulic cylinder may also be used.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A device for reverse separation and disassembly of jelly rolls, comprising:
a frame;
a limiting mechanism;
a separator striping mechanism; and
a film-drawing mechanism;
wherein the limiting mechanism, the separator stripping mechanism and the film-drawing mechanism are sequentially provided on the frame; the frame is provided with a primary cutting mechanism, and the primary cutting mechanism is configured to cut a surface separator layer of a jelly roll limited by the limiting mechanism;
the frame is provided with a lifting mechanism and an unwinding mechanism; and the lifting mechanism is configured to lift the jelly roll limited by the limiting mechanism in a Z-axis direction;
the unwinding mechanism is configured to grip and transfer the jelly roll limited by the limiting mechanism to the separator stripping mechanism, and unwind the jelly roll;
the unwinding mechanism is provided with a blowing brush connected to an air source through a pipeline;
an airflow from the blowing brush is directed toward a cut position at the surface separator layer of the jelly roll gripped by the unwinding mechanism, so as to cause an end of the surface separator layer at the cut position to be separated and gripped by the separator stripping mechanism;
the frame is further provided with a negative electrode collecting mechanism, and the negative electrode collecting mechanism is provided between the limiting mechanism and the separator stripping mechanism;
two separator separation mechanisms, two secondary cutting mechanisms and a positive electrode collecting mechanism are sequentially arranged between the separator stripping mechanism and the film-drawing mechanism;
the two separator separation mechanisms are oppositely arranged along a vertical direction;
a lower one of the two separator separation mechanisms is fixed to the frame, and an upper one of the two separator separation mechanisms is fixed to the frame via a first lifting assembly;
the two secondary cutting mechanisms are oppositely arranged in the vertical direction; and
a lower one of the two secondary cutting mechanisms is fixed to the frame, and an upper one of the two secondary cutting mechanisms is fixed to the frame via a second lifting assembly.

2. The device of claim 1, wherein the limiting mechanism comprises a material platform, a first Y-axis telescopic assembly, an X-axis telescopic assembly, a Y-axis limiting plate and an X-axis limiting plate; and the first Y-axis telescopic assembly, the X-axis telescopic assembly, the Y-axis limiting plate and the X-axis limiting plate are distributed on the material platform in a rectangular arrangement;
the material platform is provided with a sensing switch configured to detect whether the jelly roll is present within a rectangular region defined by the first Y-axis telescopic assembly, the X-axis telescopic assembly, the Y-axis limiting plate and the X-axis limiting plate;
the material platform is provided with a hole within the rectangular region;
the lifting mechanism comprises a third lifting assembly and a material pushing plate provided within the hole;
the third lifting assembly is located below the material platform, and is fixed to the material platform; and
the third lifting assembly is fixed to the material pushing plate.

3. The device of claim 2, wherein the primary cutting mechanism comprises a second Y-axis telescopic assembly and a first thermal cutting assembly;
the second Y-axis telescopic assembly is located below the material platform, and is fixed to the frame;
the second Y-axis telescopic assembly is fixed to a fourth lifting assembly, and the fourth lifting assembly is provided between the material platform and the separator stripping mechanism;
the fourth lifting assembly is fixed to the first thermal cutting assembly; and
each of the two secondary cutting mechanisms comprises a second thermal cutting assembly.

4. The device of claim 1, wherein the unwinding mechanism comprises a Y-axis moving assembly fixed to the frame;
the Y-axis moving assembly comprises a moving plate, and the moving plate is fixedly provided with a third lifting assembly;
an X-axis moving assembly is provided below the Y-axis moving assembly, and is fixed to the third lifting assembly;
two clamping assemblies are oppositely arranged below the X-axis moving assembly along an X-axis direction; and
the two clamping assemblies are configured to open and close along the X-axis direction under the action of the X-axis moving assembly;
each of the two clamping assemblies comprises a servo motor and a transmission assembly fixed to the X-axis moving assembly;
the servo motor is fixed to the transmission assembly;
a main shaft of the servo motor is fixed to an input shaft of the transmission assembly; and
an output shaft of the transmission assembly is fixed to a clamping block.

5. The device of claim 1, wherein the negative electrode collecting mechanism comprises an electric roller and a Y-axis moving assembly;
the electric roller and the Y-axis moving assembly are fixedly connected to the frame;
a rotation axis of the electric roller is configured to extend along an X-axis direction;
the Y-axis moving assembly is rotatably connected to a driven roller, and the driven roller is arranged parallel to the electric roller; and
the driven roller is configured to move close to and away from the electric roller along a Y-axis direction under the action of the Y-axis moving assembly.

6. The device of claim 1, wherein the film-drawing mechanism comprises a Y-axis moving assembly fixed to the frame;
at least one first pneumatic gripper is fixedly arranged side by side on the Y-axis moving assembly;
the separator stripping mechanism comprises a first base fixed to the frame;
a third lifting assembly is fixed below the first base;
a mounting plate is provided above the first base, and is fixed to the third lifting assembly;
a side of the mounting plate adjacent to the limiting mechanism is provided with a buffer plate and an air nozzle assembly;
at least one second pneumatic gripper is provided below the mounting plate;
the first base is fixedly provided with a fourth lifting assembly, and the fourth lifting assembly is arranged between the mounting plate and the limiting mechanism;
the fourth lifting assembly is fixedly provided with a separator stripping plate;
a side of the separator stripping plate adjacent to the limiting mechanism is rotatably provided with a transition roller;
a rotation axis of the transition roller is configured to extend along an X-axis direction; and
the separator stripping plate is provided with at least one avoidance notch respectively corresponding to the at least one first pneumatic gripper.

7. The device of claim 6, wherein the separator separation mechanism comprises a second base fixed to the frame or to the first lifting assembly;
a side of the second base away from a conveying surface is fixed to a fifth lifting assembly; wherein the conveying surface refers to a surface facing away from a remaining stacked structure in which a positive electrode is sandwiched between two separators clamped by the film-drawing mechanism;
a side of the second base adjacent to the conveying surface is provided with a separator suction assembly; and the separator suction assembly is fixed to the fifth lifting assembly, and is configured to extend along the X-axis direction;
the side of the second base adjacent to the conveying surface is fixed to a second Y-axis moving assembly;
a driven roller and an electric roller are respectively provided on two sides of the separator suction assembly;
the driven roller is rotatably connected to the second Y-axis moving assembly; and
the electric roller is fixed to the second base.

8. The device of claim 1, wherein the positive electrode collecting mechanism comprises a base plate fixed to the frame;
the base plate is provided with an X-axis moving assembly;
the X-axis moving assembly is fixed to a servo motor; and
a main shaft of the servo motor is fixed to a winding needle via a damper.

9. The device of claim 1, wherein a first pulling mechanism is provided between the separator stripping mechanism and the separator separation mechanism, and a second pulling mechanism is provided between the positive electrode collecting mechanism and the film-drawing mechanism;
the first pulling mechanism and the second pulling mechanism each comprise a driven roller and an electric roller arranged in the vertical direction;
the driven roller is fixed to the frame via a third lifting assembly;
the electric roller is fixed to the frame; and
rotation axes of the driven roller and the electric roller are each configured to extend along an X-axis direction.

10. A method for reverse separation and disassembly of jelly rolls, the method being performed based on the device of claim 1, and the method comprising:
(S100) placing the jelly roll on the limiting mechanism; and limiting, by the limiting mechanism, the jelly roll in X-axis and Y-axis directions;
(S200) cutting, by the primary cutting mechanism, the surface separator layer of the jelly roll limited by the limiting mechanism;
(S300) lifting, by the lifting mechanism, the jelly roll in the Z-axis direction;
(S400) gripping and transferring, by the unwinding mechanism, the jelly roll from the lifting mechanism to the separator stripping mechanism;
introducing air from the air source into the blowing brush through the pipeline, and blowing the air from the blowing brush toward the cut position of the surface separator layer of the jelly roll, so as to cause the end of the surface separator layer at the cut position to be separated; and
reversely rotating, by the unwinding mechanism, the jelly roll to unwind the jelly roll, such that a negative electrode end of the jelly roll falls into the negative electrode collecting mechanism by gravity, and a remaining stacked structure in which a positive electrode is sandwiched between two separators is suctioned and gripped by the separator stripping mechanism;
(S500) clamping, by the film-drawing mechanism, the remaining stacked structure, followed by resetting, wherein during a resetting process, the remaining stacked structure passes through the two separator separation mechanisms, the two secondary cutting mechanisms, and the positive electrode collecting mechanism;
(S600) moving, by the second lifting assembly, the upper one of the two secondary cutting mechanisms downward to cooperate with the lower one of the two secondary cutting mechanisms to clamp the remaining stacked structure, so as to cut the two separators on upper and lower surfaces of the positive electrode;
(S700) moving, by the first lifting assembly, the upper one of the two separator separation mechanisms downward, and actuating the two separator separation mechanisms to respectively separate the two separators on the upper and lower surfaces of the positive electrode; and
(S800) after the two separators are separated from the upper and lower surfaces of
the positive electrode, winding the positive electrode by the positive electrode collecting mechanism, and releasing, by the film-drawing mechanism, the positive electrode during winding of the positive electrode.
